(19) United States
(12) Patent Application Publication
(10) Pub. No.: US 2013/0297523 A1
(43) Pub. Date: Nov. 7, 2013

(54) SYSTEM AND METHOD FOR USING ELECTRONIC CONTACT IDENTIFIER FOR COMPLETING A SALES TRANSACTION

(71) Applicant: Giftable, LLC, Dallas, TX (US)

(72) Inventors: Nick Karr, Dallas, TX (US); Yehuda Burnham, Oak Park, MI (US); Shimon Belen, Southfield, MI (US)

(21) Appl. No.: 13/856,974

(22) Filed: Apr. 4, 2013

Related U.S. Application Data
(60) Provisional application No. 61/621,319, filed on Apr. 6, 2012.

(51) Int. Cl. G06Q 10/08

(52) U.S. Cl. CPC G06Q 10/083
USPC 705/330

(57) ABSTRACT

A computerized system and method for obtaining a shipping address needed to complete a sales transaction. In a preferred embodiment, the computerized system and method utilizes at least one electronic contact identifier to cause an electronic message, which has been generated by the system, to be delivered to an intended recipient of at least one item that has been selected for purchase at an ecommerce site. The generated message may contain a link to a webpage which can be accessed by the intended recipient and where he or she may provide the system with his or her shipping address. Upon obtaining the shipping address, the system may then cause a payment for the at least one item to be processed and the at least one item to be shipped to the obtained address.

### PRIORITY

This application claims priority to U.S. Provisional Application No. 61/621,319 which was filed on Apr. 6, 2012, which is hereby incorporated by reference in its entirety.

### TECHNICAL FIELD

Exemplary embodiments relate to systems and methods for completing sales transactions which culminate in the shipping of at least one parcel. More particularly, exemplary embodiments of the present invention relate to a computerized system and method for completing a sales transaction by obtaining at least one electronic contact identifier for the intended recipient of at least one item being purchased in a transaction and sending an electronic message to the recipient via the electronic contact identifier that has been obtained wherein the message may contain a link to a secured website where the recipient is prompted for entry of a shipping address in order to complete the sale.

### BACKGROUND AND SUMMARY OF THE INVENTION

In making a purchase, it is often times necessary to provide the merchant, seller, etc. with at least one shipping address. This occurs frequently when placing purchases on-line, but also occurs in more traditional retail settings such as when purchasing at retail stores, through a catalog, from a satellite vendor of goods, etc. The at least one shipping address enables the merchant to send the purchase or part of the purchase to the purchaser or to an individual other than the purchaser when, for example, the purchaser is buying a gift. In some instances, purchases are shipped to multiple addresses which require providing the merchant with more than one address. Providing the merchant with the at least one shipping address for a sales transaction has traditionally required the purchaser to have knowledge of the address so that he or she may supply it to the retailer. This poses a problem when the purchaser does not know the address or is uncertain if he or she has the correct address for the shipping of at least one item being purchased.

In recent history, it has become common for individuals to communicate with each other using electronic media that correspond to unique electronic contact identifiers. For example, many individuals communicate using at least one of a cell phone, email, social media account(s), twitter, computerized messaging system, etc. that correspond to a unique phone number, email address, webpage, username, etc. These electronic media and associated electronic contact identifiers (i.e. phone number, email address, media username, etc.) often times remain correlated with an individual for a much longer period of time than a physical address that might be utilized for the shipping of an item being purchased during a sales transaction. Further, electronic contact identifiers are often times easily accessible in the contacts of a purchaser's cell phone or email account, on a business card, on a public website or social media page, etc. making the electronic contact identifiers more dependable, convenient, available, etc. than a physical address for an individual. Additionally, in the case of gift-buying, there may be circumstances when the purchaser of the gift simply does not know where the recipient would prefer to receive the gift even when he or she has a dependable, current physical address for the intended recipient. For example, the recipient may prefer to have the gift sent to an office where he or she works. In other situations, an individual may be making a purchase for a business and may not know where the purchase is to be sent, but knows at least one electronic contact identifier for an individual who is likely to have the shipping address information.

While the art has developed systems that correlate email addresses with shipping addresses, these systems rely on previously assembled databases that correlate each email address with a physical address. These systems accordingly require the email address to be entered into a database and correlated with an address. If the information has not been entered, the system cannot obtain shipping information upon obtaining the email address. Further, these systems do not provide for flexibility. The address which has been entered into the database and correlated with the email address is that which is utilized for shipping, despite the fact that the address may have changed recently. These systems are essentially electronic address books which may be searched using an email address and they do not solve the problems existing in the marketplace. There is a need in the art for a system that may utilize one or more of a variety of electronic contact identifiers to obtain a shipping address needed to complete a sales transaction wherein the shipping address may be provided specifically for the sales transaction in question by the intended recipient of at least one item being purchased, by an individual at the entity which will be receiving at least one item being purchased, by someone the purchaser believes to be in possession of the correct shipping information, etc.

An exemplary embodiment comprises a system which enables the completion of a sales transaction when a shipping address needed to ship at least one item selected for purchase in the transaction is unknown, unverified, etc. The system may complete the sales transaction by obtaining at least one electronic contact identifier for the intended recipient of the at least one item from the individual or entity that initiated the sales transaction and by utilizing the at least one electronic contact identifier to obtain the address. For example, at least one server running an on-line shopping website or in electronic communication with an on-line shopping website such as, but not limited to, amazon.com, walmart.com, target.com, barnesandnoble.com, gap.com, anntaylor.com, potterybarn.com, saks.com, etc., may provide for the completion of a sales transaction by permitting a system user to enter at least one electronic contact identifier in lieu of a shipping address that may be needed to ship at least one item being purchased through the shopping website. The system user is preferably an individual attempting to purchase at least one item through the shopping website or an individual with the permission and authority to make a purchase on behalf of another at the shopping website. The system user may communicate with the system server via an electronic computing device that is in electronic communication with the server, for example a computer accessing the shopping website over the internet. The system user may enter an electronic contact identifier in lieu of a shipping address when at least one item being purchased through the shopping website needs to be shipped to an address other than that which has been provided by the system user as the billing address that correlates to the payment for the purchase and the system user is uncertain of the appropriate shipping address, does not wish to spend the time entering the address, wants to ensure the recipient wishes to receive a gift before making the purchase, etc.

In preferred exemplary embodiments, the server is able to receive from the system user a variety of electronic contact identifiers in order to complete a sales transaction. For example, the system user may enter one or all of an email address, a telephone number, a twitter username, a social media account webpage, etc. and cause the entered electronic contact identifier(s) to be sent to the server. Upon receipt of unique electronic contact identifier(s), the system server may generate a message that comprises a secure link to a website and cause the message to be sent via the electronic contact media which correspond to the received unique identifiers. So for example, if the server receives an email address and a phone number from the system user in lieu of at least one shipping address, the server may generate an email and a text message both of which contain a secure link to a website and send the messages to the obtained email address and phone number respectively. In a preferred exemplary embodiment, the generated message(s) is/are later accessed by an individual or entity associated with the unique electronic contact identifiers. In other words, an individual or entity associated with the email account, twitter account, phone number, social media account, etc. This may be because the individual or entity is the intended recipient of at least one item being purchased in an order placed through the shopping website. Once the generated message(s) is/are accessed, the secure link may be entered into a web browser causing the browser to display a web page which prompts for the entry of a shipping address. The web page may also indicate what item(s) will be shipped if the shipping address is provided and may also indicate who has purchased the item(s) however in some exemplary embodiments some or all of this information may not be displayed permitting for purchaser anonymity and/or surprise gift-giving. In some exemplary embodiments, the system user that provided the electronic contact identifiers to the system may be able to control what is displayed at the web page. In some exemplary embodiments, the web page where the shipping address may be provided to the system is part of the ecommerce site where the sales transaction was initiated.

In a preferred exemplary embodiment, once a shipping address has been entered at the web page, the shipping address is sent to the at least one server which may then correlate the shipping information to the appropriate purchase/item(s) and cause a payment for the purchase/item(s) to be processed. Similarly, if a shipping address is never entered at the web page, because for example the generated messages were never accessed or because the individual or entity associated with the electronic communication identifier declined to enter a shipping address, the server may decline to process a payment for a purchase/item(s). In such exemplary embodiments, the server may generate and send a message to the system user that entered the electronic contact identifier (the “purchaser”) wherein the message indicates that at least a portion of the placed order was not processed and may also provide a reason for such. Accordingly, the server may also obtain electronic contact identifiers for the purchaser when the original order is being placed to enable the sending of such messages and to enable additional communications.

In some exemplary embodiments, the system obtains a shipping address corresponding to at least part of a purchase that was not placed over an online shopping site. The purchase may have been made at a retail store, through a catalog, over the phone to a merchant, etc. In such exemplary embodiments, at least one system server may run a webpage which may be accessed by a system user for the entry of at least one electronic contact identifier that will be used to obtain shipping information for at least one item being purchased. The system user may be a merchant that has obtained an order for merchandise, a purchaser using the system at a retail store, etc. In some exemplary embodiments, the system server may also prompt the user for entry of information pertaining to the item which has been or is desired to be purchased, order information such as a corresponding order number, etc. In some exemplary embodiments, once the server has obtained information from a system user, it sends the information to a database where order/purchase information is correlated to the obtained electronic contact identifier(s). Once the system has obtained the electronic contact identifier(s) it may generate a message comprising a secure link to a webpage where a shipping address may be entered and sent to the at least one system server. The system server may receive the shipping address and correlate it to the corresponding order information that has been saved in the database. The server may then cause a payment for the portion of the purchase that corresponds to the received shipping address (which may be all of the purchase but may also be a lesser portion in some exemplary embodiments) to be processed and cause the portion of the purchase to be sent to the obtained shipping address. In exemplary embodiments where the purchase was already placed, the system may generate a message that the purchase is ready to be shipped.

An exemplary embodiment comprises a computerized system for obtaining a shipping address needed to complete a sales transaction. The system may comprise at least one server in electronic communication with a database wherein the at least one server is adapted to receive electronic contact identifier data and sales transaction data from a remote electronic computing device. The sales transaction data may comprise information which identifies at least one item selected for purchase from a retailer that needs to be shipped to an address that is to be obtained by the system. The at least one server may further be adapted to send the sales transaction data to the database for storage and generate an electronic message which comprises a link to a webpage where a shipping address may be entered. Once the message comprising the secure link has been generated, the at least one system server may cause the message to be sent using the obtained electronic contact identification data. The system server may further be adapted to generate at least one webpage that is accessible using the secure link wherein the webpage displays at least one data entry field for entry of the shipping address. The at least one server may be adapted to receive the shipping address that has been provided to the at least one data field of the webpage, initiate payment processing for the at least one item, and cause the at least one item to be shipped to the shipping address.

In addition to the novel features and advantages mentioned above, other benefits will be readily apparent from the following descriptions of the drawings and exemplary embodiments.

### BRIEF DESCRIPTION OF THE DRAWINGS

Novel features and advantages of the present invention, in addition to those mentioned above, will become apparent to those skilled in the art from a reading of the following detailed description in conjunction with the accompanying drawings wherein identical characters refer to identical parts and in which:

FIG. 1 is an exemplary embodiment of the overall structure of a system and method for using an electronic communication identifier to obtain shipping information needed to complete a purchase that has been placed through an ecommerce site;

FIG. 2 is a screen shot of an exemplary embodiment of a web page which may be displayed by the present system for obtaining at least one electronic contact identifier that will be utilized to gain shipping information shown with exemplary purchaser and electronic contact identifiers having been entered in exemplary fields;

FIG. 3 is a screen shot of an exemplary embodiment of a web page which may be generated by the present system wherein a system user may be able to associate purchased items with electronic contact identifiers that have been entered;

FIG. 4 shows a screen shot of an exemplary embodiment of a web page that may be generated by the present system whereby a system user may instruct the system regarding what information is to be displayed at the shipping address entry page;

FIG. 5 shows an exemplary email message that may be generated and sent by the system comprising an exemplary link to a shipping address entry page;

FIG. 6 is a screen shot of an exemplary embodiment of a shipping address entry page that may be generated by the system for obtaining a shipping address;

FIG. 7 is a flow chart for an exemplary embodiment of the system and method of the present invention; and

FIG. 8 is an exemplary embodiment of the overall structure of a system and method for using an electronic communication identifier to obtain shipping information needed to complete a purchase that was not placed through an ecommerce site.

### DETAILED DESCRIPTION OF EXEMPLARY EMBODIMENT(S)

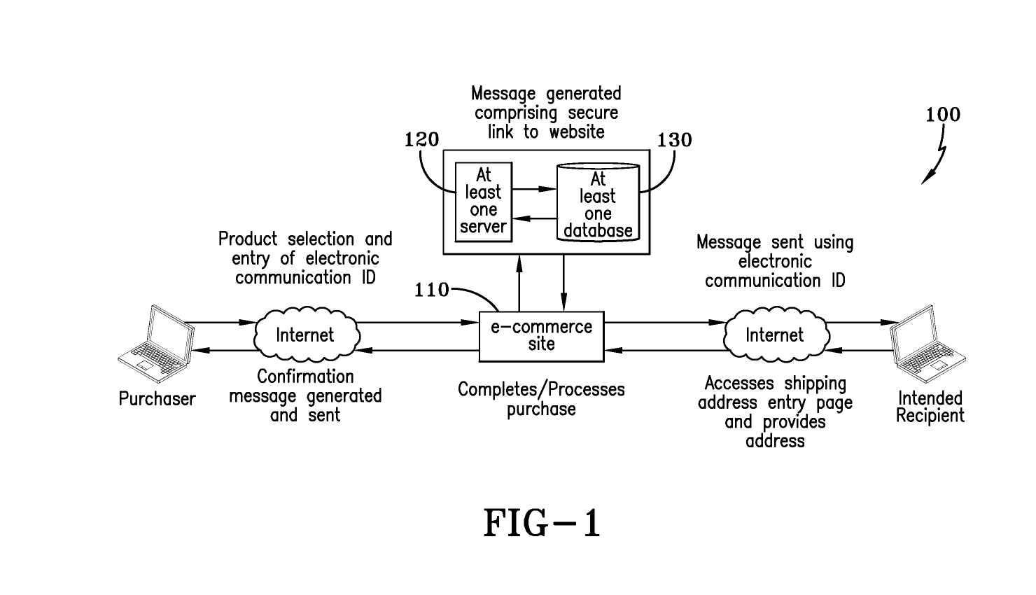

As shown in FIG. 1, an exemplary embodiment may comprise a system 100 for using at least one electronic contact identifier to obtain a shipping address needed to complete a purchase that has been placed through an ecommerce site 110. In a preferred exemplary embodiment, a system user selects at least one item from the ecommerce site 110 for purchase. During checkout at the ecommerce site 110, at a site utilized by the ecommerce site for completing sales transactions, etc. the system user may enter payment information, such as credit card number and billing address, and may then indicate that at least one item selected for purchase may need to be shipped to an address other than the payment address that has been entered. The indication may be made by entering at least one electronic contact identifier, such as a phone number, email address, personal webpage URL (myspace, facebook, etc.), twitter username, etc., into a field existing on the webpage. Having obtained the at least one electronic contact identifier, the ecommerce site 110 may send it along with sales transaction data via at least one server 120 to at least one database 130. The at least one database 130 may store the electronic contact identifier along with a sales transaction identifier and may correlate at least one item purchased in the transaction with the electronic contact identifier. Having received the at least one electronic contract identifier, the at least one server 120 may generate a message to be sent using media corresponding to the electronic contact identifier wherein said message comprises a secure link to a shipping address entry page.

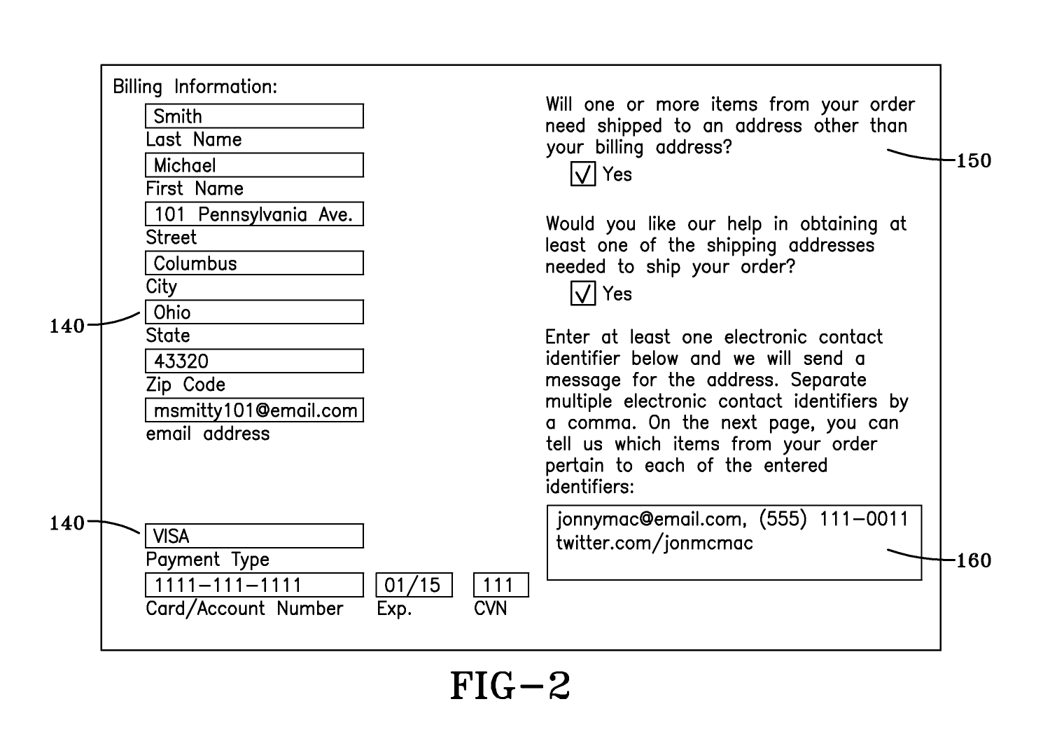

FIG. 2 shows a screen shot of an exemplary webpage that may be utilized to obtain at least one electronic contact identifier that will be used by the system to obtain at least one shipping address for completing a sales transaction. As shown, the page may comprise billing information entry fields 140 where the purchaser enters his or her billing information, at least one different shipping address indication field 150 where the purchaser may indicate to the system that at least one item needs to be shipped to an address other than the billing address, and at least one electronic contact identifier entry field 160. Once the system has obtained at least one electronic contact identifier, it may generate at least one message comprising a secure link to a webpage where a shipping address may be entered. The system may cause the message(s) to be sent using the electronic media that corresponds to the at least one electronic contact identifier that was obtained. For example, if the system user entered an email address and a twitter username as electronic contact identifiers the system may generate an email message and a “tweet” both of which may comprise a secure link to a webpage. Once the messages are accessed, preferably by the individual or entity associated with the electronic contact identifier, the link may be entered into a web browser, selected with an electronic pointer, etc. causing a webpage to be displayed that prompts for the entry of a shipping address.

In some exemplary embodiments, a system-generated message may contain a secure link as has been discussed as well as a unique code. The secure link may be accessed to direct the intended recipient to a webpage where a shipping address may be entered. However, the unique code may provide an alternative means of providing the system with a shipping address. The message may indicate that the intended recipient may access the website of the ecommerce retailer where the unique code may be entered. Upon detecting entry of the unique code, the system may display a webpage where a shipping address needed to complete a sales transaction may be entered. In some exemplary embodiments, the system may generate a message which contains a unique code in lieu of a secure link. In preferred exemplary embodiments the system-generated message(s) are sent by the system using the electronic contact identifier(s) that were supplied to the system during the checkout process at an ecommerce site.

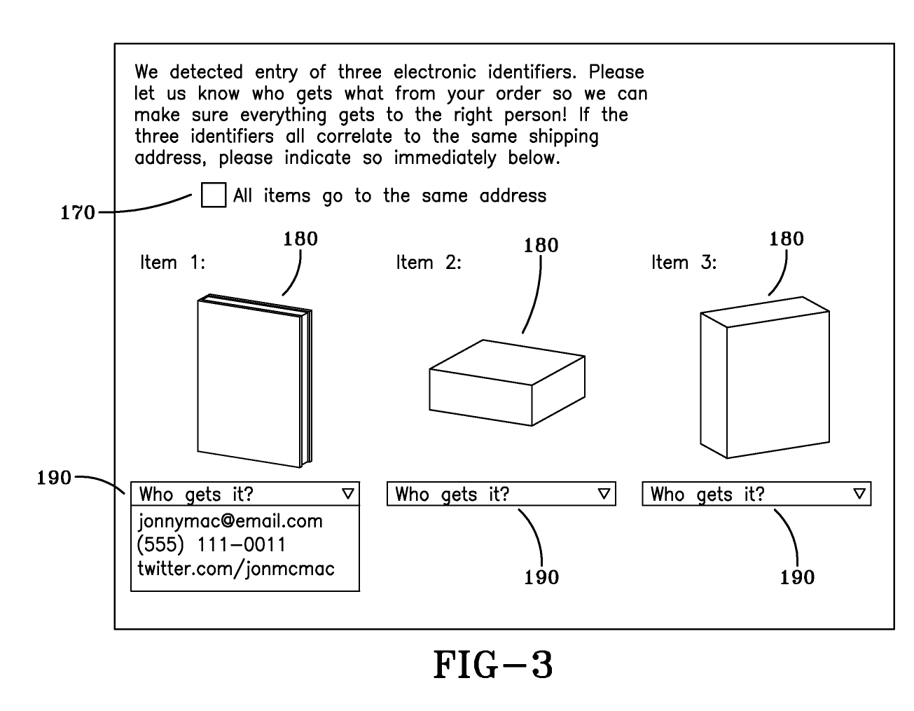

In some exemplary embodiments, the system permits for the entry of multiple electronic contact identifiers in order to obtain shipping information for completing a sales transaction. This may be because items purchased need to be shipped to more than one person or place but also because entering more than one electronic contact identifier increases the probability of obtaining a shipping address, etc. In other words more than one electronic contact identifier may be obtained by the system even if only one shipping address is needed for completion of the transaction. When multiple electronic contact identifiers are obtained because more than one shipping address is needed, the system preferably permits the purchaser to correlate at least one electronic contact identifier with at least one item being purchased and stores the information in a database so that if at least one of the shipping addresses is ultimately obtained by the system, it may be correlated with the appropriate item(s) from the purchase. FIG. 3 shows an exemplary embodiment of a webpage that may be generated by the system wherein a system user may correlate at least one electronic contact identifier that has been entered with items that have been ordered in a sales transaction. As shown, the page may display at least one single shipping address indication field 170 which may be utilized by the purchaser to indicate that all items are to be shipped to the same address, at least one purchased item identifier 180 which may as shown be an image of the purchased item, and at least one electronic contact identifier correlation field 190 which permits the system user to correlate at least one purchased item with an entered electronic contact identifier. In some embodiments, the system may specifically prompt the purchaser/system user placing the order to indicate how many shipping addresses are needed for the transaction.

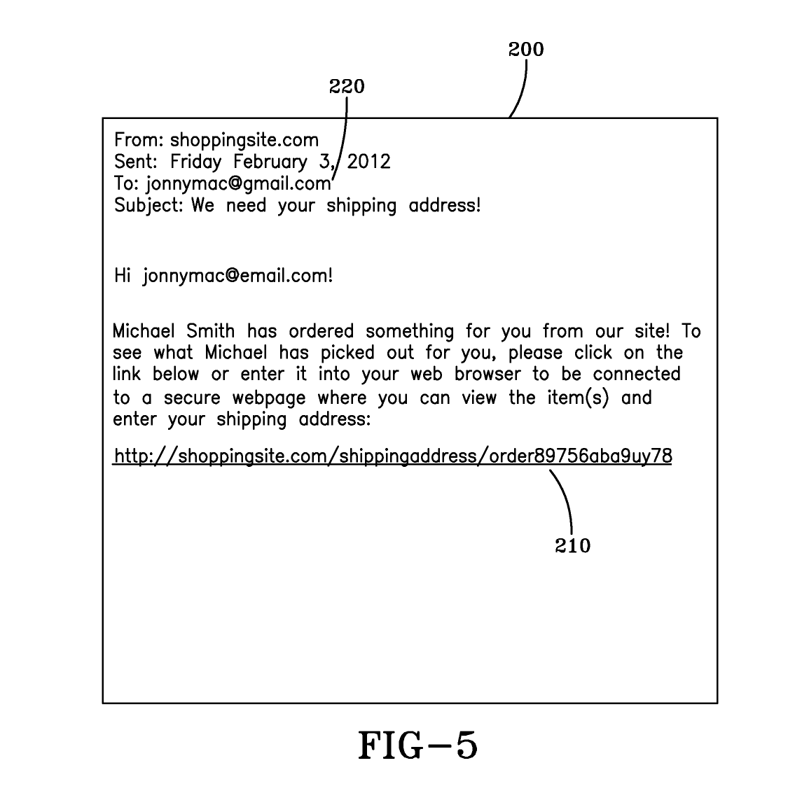

As discussed, in some exemplary embodiments obtaining at least one electronic contact identifier causes the system to generate a message which is then sent via the electronic media which corresponds to the electronic contact identifier. In a preferred exemplary embodiment, the message will contain a secure link to a webpage where shipping information may be entered. FIG. 5 shows an exemplary embodiment of an email message 200 comprising a secure link 210 that may be generated by the system and sent using an obtained electronic contact identifier 220. In some exemplary embodiments, the system permits the system user to include a personal message for the intended recipient within the system-generated message. For example, the purchaser may wish to identify him or herself, say hello to the intended recipient, extend holiday greetings, etc. The system may permit the purchaser to include such sentiments within the body of the system-generated message,

In some exemplary embodiments, a system that permits for the completion of a sales transaction by obtaining at least one electronic contact identifier then utilized by the system to obtain a shipping address, may also permit for alternative means of obtaining a needed shipping address. For example, the system may accept manual entry of shipping addresses needed to complete a sales transaction. The system may also generate a message(s) to the intended recipient of at least one item selected for purchase in a sales transaction, cause the message(s) to be transmitted using at least one obtained electronic contact identifier, and obtain the needed shipping address when the intended recipient responds to at least one transmitted message with a message that contains the shipping address. In another exemplary embodiment, the system may permit a system user to obtain at least one shipping address needed to complete a sales transaction from a place in which it is electronically available. For example, during checkout from an ecommerce site, the system may display a link which permits the system user to sign into an electronic account which contains the needed address (i.e. gmail, email, outlook, twitter, facebook, etc.) and obtain the address. In a preferred exemplary embodiment, the system offers this functionality in addition to the ability to obtain a shipping address by providing the system with at least one electronic contact identifier. In exemplary embodiments where more than one shipping address is needed to complete a sales transaction, a system user may provide the system with at least one electronic contact identifier(s) in order to obtain a first shipping address and may access an electronic account in order to provide the system with a second shipping address needed to complete a sales transaction.

Some exemplary embodiments comprise a system for obtaining a shipping address needed to complete a sales transaction that utilizes an API, another type of software interface, etc. to gain access to the shipping address when it is stored within a database or server. In some exemplary embodiments, the API may permit a system user to sign into an account which provides access to the database or server which contains the needed shipping address such that the system may obtain the address directly from the server or database. In preferred exemplary embodiments, the system offers this functionality in addition to being able to obtain a shipping address through utilization of at least one electronic contact identifier which has been obtained by a system user. In another exemplary embodiment, the system may utilize the API, another software interface, etc. to access the purchaser's contact list from a server or database (including, but not limited to Outlook, Google contacts, etc.) to obtain at least one electronic contact identifier associated with the intended recipient of at least one item selected for purchase in the sales transaction for the purpose of providing the intended recipient with a unique code and/or secure link that could be utilized by the intended recipient to provide the system with the needed shipping address, a request for the preferred shipping location, etc.

In other exemplary embodiments, utilization of an API, another type of software interface, etc. may permit a system user, such as the individual or entity that has initiated a sales transaction, to sign into an account, such as a Facebook account, LinkedIn account, email account, etc., where the intended recipient of at least one item selected for purchase during the sales transaction is a contact, friend, etc. of the individual or entity. Signing into the account may permit the initiator of the sales transaction to indicate to the system which contact, friend, etc. is the intended recipient of at least one item selected for purchase in the sales transaction. Once the intended recipient has been indicated to the system, the system may be able to message the intended recipient through the accessed Facebook, LinkedIn, email, etc. In other words, upon identifying, selecting, etc. the intended recipient, the intended recipient could be contacted via that/those medium(s) utilized to obtain the needed shipping address (facebook/linkedin/twitter, etc.), and would be provided by the system with a unique code and/or secure link that could be utilized to provide the system with the needed shipping address, a request for the preferred shipping location, etc. For example, if the initiator of a sales transaction wishes to send at least one item selected for purchase during the transaction to one of his Facebook Friends, the API of the system may permit the initiator to sign into his Facebook account and select, identify, etc. the intended recipient (thereby indicating the intended recipient to the system). Once the intended recipient has been selected, identified, etc. the system may then be able to send a Facebook message to the intended recipient wherein the message may comprise a secure link and/or a unique code which may be utilized by the intended recipient to provide the system with the shipping address. In another exemplary embodiment, the message is dynamic and permits for entry of the shipping address within data fields of the message thereby making the shipping address available to the system.

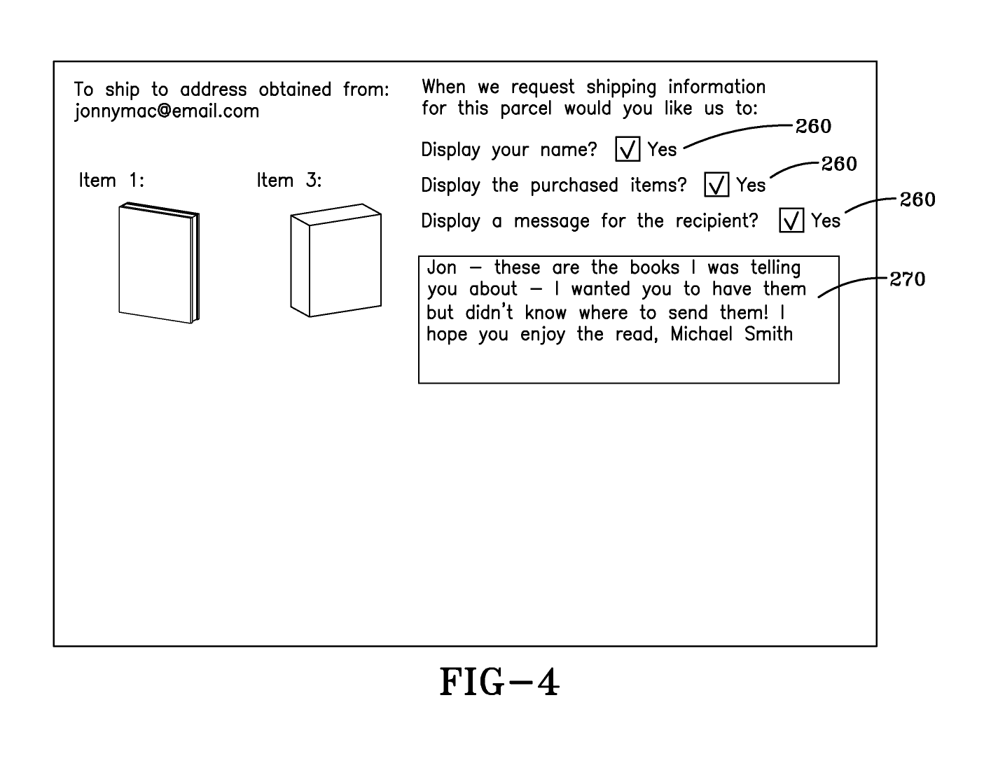

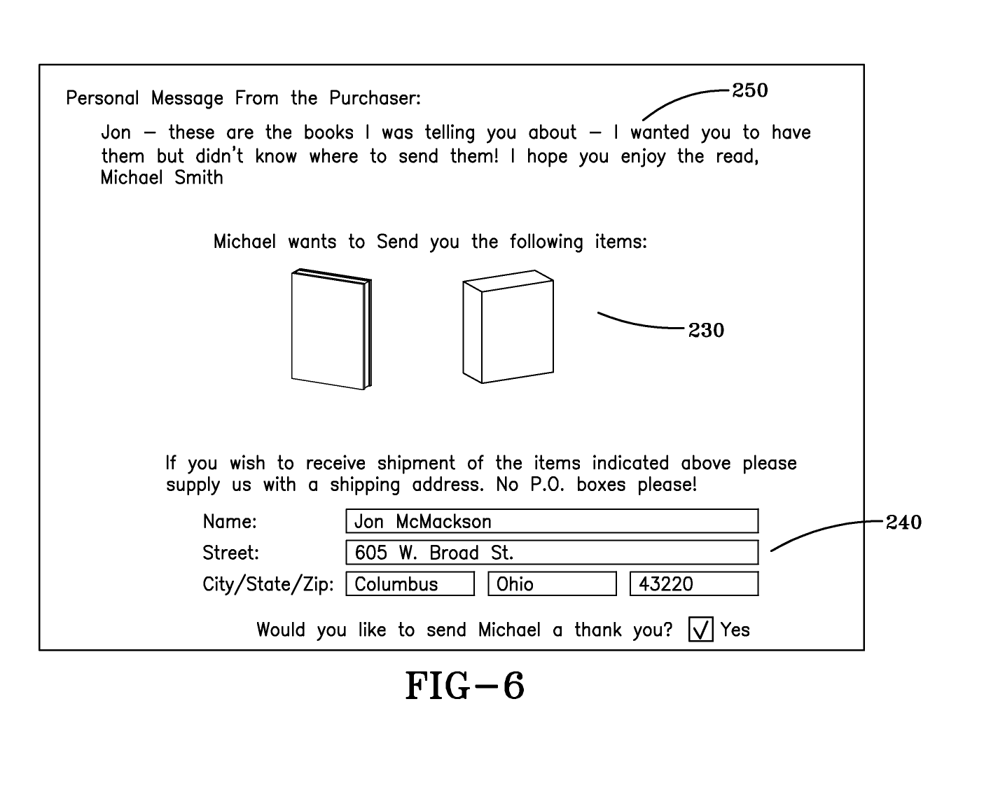

A webpage that may be generated by the system and accessed for the entry of shipping information will be referred to as the shipping address entry page. FIG. 6 shows an exemplary embodiment of a shipping address entry page that may be generated by the present system to prompt for the entry of a shipping address. As shown, the shipping address entry page may include an indication of what item(s) has been purchased and by whom 230 and may further include at least one data entry field for obtaining a shipping address 240 where the displayed item(s) may be shipped. As shown in FIG. 6, the shipping address entry page may further contain a personal message 250 from the system user that initiated the sales transaction. In other exemplary embodiments, a shipping address entry page does not indicate what item(s) has been purchased and/or by whom. Such exemplary embodiments may permit for anonymous and/or surprise gift giving. A purchaser may be able to control what information relating to the item(s) selected for purchase and purchaser information is displayed by the shipping address entry page. FIG. 4 shows an exemplary embodiment of a webpage that may be generated by the system wherein a purchaser may control what information is displayed at the shipping address entry page. As shown in FIG. 4, such a webpage may comprise at least one field 260 which permits the system user to instruct the system as to what information is to be displayed at the shipping address entry page. The page may further comprise a personal message entry field 270 which permits a system user to compose a personal message for the recipient of at least one item being purchased so that it may be displayed at the shipping address entry page. In some exemplary embodiments, the data entered into the fields 260 and 270 is sent to at least one server which causes the data to be stored in at least one database correlated to sales transaction data and/or a unique electronic identifier which was also provided to the system by the system user. The data may also be or alternatively be correlated to a secure link to a shipping address entry page that is generated by the system. Accordingly, the data may subsequently be accessed and utilized to generate a shipping address entry page when the secure link is accessed/entered into a web browser by the intended recipient of at least one item selected for purchase in a sales transaction. A shipping address entry page may consist of more than a single webpage in some exemplary embodiments.

In some exemplary embodiments, a shipping address entry page contains at least one field for data entry in addition to a shipping address and may permit for additional system functions. For example, the page may contain a field which when selected causes the system to generate and send a message, such as a thank you note, to the individual who made the purchase. The page may also permit for entry of text which is to be contained in the message. In a preferred exemplary embodiment, a shipping address entry page displays a variety of cards, such as physical cards or ecards, one or more of which may be selected by the individual that has entered (or will enter or is prompted to enter) a shipping address for delivery to the individual that has made the purchase. In some exemplary embodiments the system prompts the intended recipient of at least one item selected for purchase in a sales transaction as to whether he or she wishes to send a thank you not to the purchaser of the at least one item. In some examples, the system may generate a thank you message automatically or upon the request of the intended recipient at a shipping address entry page. In some exemplary embodiments, the thank you messages may be customized before they are sent. In a preferred exemplary embodiment, such a message may be delivered because the system obtained the purchaser's address, email address, etc. when the order was initially placed at the ecommerce site.

In some exemplary embodiments, the system may provide functionality to the intended recipient of at least one item selected for purchase during a sales transaction in addition to obtaining his or her shipping address for completion of the transaction. The additional functionality of sending a message, such as a thank you note, to the purchaser of at least one item intended to be shipped to the recipient has been discussed, but other functions are also possible. For example, the system may prompt the recipient to purchase an item at an ecommerce site, which in preferred exemplary embodiments is the same ecommerce site which was utilized for placing the initial sales transaction, but may be another site in some exemplary embodiments. In some exemplary embodiments, the system prompts the recipient to purchase an item which coordinates with, compliments, etc. at least one of the items which was selected for purchase and for shipment to the recipient. For example, if one of the items selected for purchase/for shipping to the intended recipient is a book in a series, the system may indicate that the book has been purchased for him or her and may indicate that the other books in the series are available at the ecommerce site where the purchase was initially placed. In another example, the system may recommend a product of similar type to that which has been purchased for the intended recipient. In another exemplary embodiment, the system may prompt the recipient to purchase an item for the individual or entity that selected at least one item to be purchased/sent to the recipient. In such an exemplary embodiment the system may ask the recipient if he or she wants to purchase an item to be sent to the individual that has selected an item for purchase/shipping to the recipient and permit the recipient to select an item for purchase at an ecommerce site. The system may recommend items for purchase based on transaction history at the ecommerce site which is maintained in at least one database of the system. The system may utilize an address obtained during the initial sales transaction to ship the at least one item selected for purchase, however in some exemplary embodiments the system may prompt for entry of at least one electronic communication identifier(s) that may be utilized to obtain a shipping address in the manners that have been discussed herein. In some exemplary embodiments, the system may prompt the recipient of at least one item selected for purchase through an ecommerce site to open an account with the ecommerce site.

In some exemplary embodiments, a shipping address entry page generated by the system prompts for the entry of an electronic contact identifier which may be utilized by the system to send a message from the intended recipient of at least one purchased item to the item's purchaser. To facilitate messaging to the purchaser, a shipping address entry page may contain at least three fields. One of the fields may be for entry of the shipping address. The other two fields may be for entry of a message to be sent to the purchaser and a corresponding electronic contact identifier. A system user may be able to use the fields to send a question to the purchaser such as a question asking what has been purchased, why the purchase has been made, etc. The system may send the message to the purchaser via the electronic media which corresponds to the electronic contact identifier that has been obtained through the shipping address entry page. Permitting for the sending of such messages may permit the intended recipient of at least one item being purchased in a transaction to ensure that he or she knows who is sending the item and that he or she desires to receive it before entering his or her shipping information. These messages may not be needed when the system displays what has been purchased and by whom at the shipping address entry page, but the system may nonetheless permit for the messages to be sent. In some exemplary embodiments, once a shipping address has been entered at a shipping address entry page it may be stored in a database where it is correlated to at least one electronic contact identifier. In some exemplary embodiments, the database may be accessed for searching by entry of the at least one electronic contact identifier, name, etc.

In some exemplary embodiments, the system obtains a shipping address for the shipment of at least one item being purchased through an ecommerce site in a manner which may not require the utilization of a shipping address entry page. For example, the system may obtain an electronic contact identifier from the system user that has initiated the sales transaction and upon receipt of the electronic contact identifier may generate a message to be sent via the electronic media that corresponds to the received electronic contact identifier. In one exemplary embodiment, the system-generated message is an email message that contains data entry fields. In such an exemplary embodiment, when the email message is received and accessed, the data entry fields may be used to enter a shipping address to which at least one item selected for purchase during the sales transaction may be sent and may also be utilized to send the shipping address to the system. In other words, the message generated by the system may be dynamic and may enable a shipping address to be provided to the system.

In another exemplary embodiment, the system obtains at least one shipping address needed to complete a sales transaction by generating a message during the checkout process at an ecommerce site which may then be sent by the individual or entity initiating the sales transaction. For example, during the checkout process, the system may generate and display a webpage which presents the system user, who has initiated a sales transaction, with the option of generating a message which may then be sent in order to obtain at least one shipping address needed to complete the sales transaction. If the system user exercises the option, the system may generate a message which may be sent by the user via his or her email account, text message, etc. using an electronic contact identifier corresponding to the intended recipient of at least one item being purchased during the sales transaction. The message may be dynamic, it may contain a secure link to a shipping address entry page, etc.

In another exemplary embodiment, the system does not generate a message to be sent by the system user or the system, but instead generates a secure link to a shipping address entry page. The system user that has initiated the sales transaction may then generate a message via an email account, text message, instant message, etc. and incorporate the secure link into the message which may then be sent using at least one electronic contact identifier that corresponds to the intended recipient of at least one item selected for purchase during the sales transaction.

As has been discussed, some exemplary embodiments of the system and method of the present invention may comprise the generation of a unique code which is needed to provide the system with a shipping address. For example, some exemplary embodiments of the system may generate a unique code that corresponds to at least part of an order that has been placed at an ecommerce site. The system may generate and display the code during the checkout process upon being informed that the system needs to obtain at least one shipping address for completion of the transaction. The system user may then incorporate the generated code into a message which is then sent by the system user to the intended recipient of at least one item selected for purchase during the transaction. In another exemplary embodiment, the system may generate a message comprising the unique code and send the message using at least one electronic contact identifier which has been obtained by the system from the system user during the checkout process. The ecommerce site at which the sales transaction was initiated, or a website operating on behalf of the ecommerce site, may permit for entry of the generated code. The code may be entered in conjunction with a shipping address or as a precursor to entry of the shipping address. In some exemplary embodiments, the code permits for connection to part of the ecommerce site which obtains the shipping address. When a unique code has been generated by the system, the system in some embodiments may not accept a shipping address unless the unique code has been provided to it in conjunction with or prior to entry of the shipping address. Receipt of the code by the system may occur at a shipping address entry page in some exemplary embodiments.

When the system has obtained at least one shipping address needed to complete a sales transaction, the system may implement a validation step. In an exemplary validation step, the system generates a message containing the at least one shipping address which has been obtained by the system and sends the message to a previously obtained electronic contact identifier which corresponds to the individual or entity that initiated the sales transaction. The message may be dynamic and permit for the validation of the shipping address through the selection of a validation indicator located within the message. In another exemplary embodiment, the message may contain a link to a secure page where the at least one shipping address may be validated. In another exemplary embodiment, the message generated may not contain the at least one shipping address obtained by the system, but may indicate that at least one shipping address has been obtained and may indicate that the address is ready for validation at a particular webpage. A secure link to the webpage may be included within the message. A password may be needed to access the validation webpage. In some exemplary embodiments the password may have been selected by the individual or entity that initiated the sales transaction when the transaction was being initiated. In some exemplary embodiments comprising a validation step, failure to validate at least one obtained shipping address may result in the cancellation of part or all of the sales transaction.

In a preferred exemplary embodiment, the system obtains a shipping address for the shipment of at least one item being purchased through an ecommerce site after it has been entered at a shipping address entry page or via another mechanism such as through a dynamic system-generated message. At that point the system may cause a payment to be processed for the at least one item which will be shipped to the obtained address. Processing a payment may mean sending an electronic request for payment to an account corresponding to an account number which was entered by the purchaser. Processing a payment may also mean debiting or charging an account for a payment correlating to an order that has been made at an ecommerce site, a purchase made at a merchant, etc. However, one of ordinary skill in the art upon reading the disclosure of the present application will understand there are a variety of ways the system and method of the present invention may initiate a payment/cause a payment to be processed. Once the payment has been processed, the system may cause the at least one item to be shipped to the obtained address completing the transaction. In some exemplary embodiments, a shipping address is not obtained by the system. This may be because a system-generated message containing the link to a shipping address entry page was never accessed, because the intended recipient declined to enter a shipping address, etc. In such exemplary embodiments where the system has not obtained a shipping address, the system may cancel a sales transaction after the passage of a predetermined time period. For example, the sales transaction may be cancelled if no shipping address is obtained by the system within ten days of the transaction's initiation. The system may permit the purchaser to set a time period during which the shipping address may be obtained before the transaction is cancelled by the system. In such exemplary embodiments, the system may set a maximum and/or minimum time period for cancellation.

Alternatively, in some exemplary embodiments, the system may return at least part of a payment that was previously rendered for a purchase because a shipping address needed to complete the transaction was never obtained by the system. In such an exemplary embodiment, an order may be placed at an ecommerce site and paid for by a purchaser. During the transaction, the purchaser may indicate that the system needs to obtain a shipping address for at least one of the items that has been purchased and may accordingly provide the system with at least one electronic contact identifier to use in obtaining the shipping address. The system may generate a message comprising a secure link to a shipping address entry page and may send the message via the electronic communication medium corresponding to the identifier. If a shipping address is never obtained by the system at the shipping address entry page, the system preferably detects the lack of entry. This may occur at a previously determined point in time such as, for example, ten days after the purchase was made. If the system never obtains a shipping address via the shipping address entry page, the system may cause a refund to be issued for the item(s) that the purchaser intended to be shipped to the address that was never obtained. In some exemplary embodiments, the system causes a credit to be made to a credit or debit card account to refund at least part of an earlier rendered payment.

In exemplary embodiments where the system is adapted to cancel or refund at least part of an order when a shipping address has not been provided in a predetermined period of time, the system may generate a message which is electronically sent to the purchaser. The message may tell the purchaser that a shipping address has not been obtained so that the purchaser may get in touch with the intended recipient to remind him to provide the system with a shipping address. In some exemplary embodiments, the system may give the purchaser the option of having a duplicate message sent to the intended recipient. The duplicate message may be of the same type which was initially sent to the intended recipient. For example, if the system generated an email with a secure link to a shipping address entry page and then sent the message to the recipient via an electronic contact identifier which was supplied to the system during the checkout process by the purchaser, the duplicate message may be an email containing the same secure link which the system sends to the same email address. The duplicate message may remind the intended recipient that a shipping address is needed and provide information regarding a time period during which the shipping address must be obtained before the transaction is cancelled, refunded, etc.

In some exemplary embodiments, the system may provide a purchaser with the option of completing a sales transaction in at least two ways. For example, the system may permit the purchaser to indicate that a shipping address needs to be obtained for the shipping of at least one item that has been selected for purchase during a sales transaction and may attempt to obtain the shipping address as has been discussed. However, the system may permit the purchaser to indicate that if a shipping address cannot be obtained, the at least one item should be shipped to another address that is supplied by the purchaser. The purchaser may supply the system with the alternative shipping address at the time of purchase. In some exemplary embodiments the purchaser may have the at least one item sent to his or her shipping address in the case that the intended recipient does not ultimately supply the system a shipping address. In such exemplary embodiments, the system would not cancel the sales transaction simply because a shipping address was not supplied by the intended recipient of at least one item selected for purchase at an ecommerce site.

In preferred exemplary embodiments, a purchaser that uses the system to obtain at least one shipping address needed to complete a sales transaction provides the system with at least one electronic contact identifier that may be utilized to keep the purchaser updated regarding status of the transaction. For example, the system may obtain a phone number for the purchaser which may be used to send informative text messages. Text messages sent to the purchaser may include:
a. A message has successfully been sent to [electronic contact identifier] requesting that a shipping address be provided so that we may complete your transaction with [ecommerce site].
b. [electronic contact identifier] has accessed the shipping address entry page & provided a shipping address for order no. [number] placed with [ecommerce site]. We have completed processing your purchase!
c. We have shipped [indicate item(s)] to the address provided by [electronic contact identifier]. You may track the shipment by accessing the following link: [indicate tracking link]

These are just exemplary messages and not meant to be limiting of the types of messages which may be sent by the system. Further, email messages and messages of other types may also be utilized to keep the purchaser informed regarding the status of the sales transaction.

In a preferred exemplary embodiment, when the system has obtained a shipping address needed to ship at least one item purchased in a sales transaction, the system may initiate shipment of the at least one item to the shipping address. In some exemplary embodiments, this may comprise the steps of generating an electronic message and transmitting the message to a facility where the at least one item is being housed or to a facility/entity that has control over the at least one item. The message may indicate that the item, which may be identified by an item number, has been purchased and needs to be shipped. The message preferably indicates the shipping method and shipping address. In some exemplary embodiments, initiating shipment of at least one item to the shipping address may comprise the steps of updating an inventory to account for the purchase of the at least one item and transmitting an electronic message to a shipping department, facility, entity, etc. that indicates the at least one message needs to be shipped. The message may indicate how the item is to be shipped and to where. In another exemplary embodiment, the system sends the shipping address to a database where it is correlated with sales transaction date (i.e. order number, item number(s), etc.). Initiating shipment of at least one item may comprise the steps of generating an electronic message indicating that at least part of the order (which may be identified by order number) is ready to ship. The entity, facility, etc. responsible for shipping the at least one item or preparing the at least one item for shipping may at that point be able to access the database to obtain the shipping address and other information which may be needed to ship the item.

A preferred exemplary embodiment of a system for completing a sales transaction initiated through an ecommerce site may comprise at least one server in electronic communication with a database wherein the at least one server is adapted to receive at least one electronic contact identifier which the system will utilize to obtain a shipping address needed to complete the sales transaction. In some exemplary embodiments, the at least one server generates the ecommerce site where the sales transaction was initiated, the order was placed, etc. In other exemplary embodiments, the at least one server may be in electronic communication with the ecommerce site but may not necessarily generate the site. The at least one server may obtain at least one electronic contact identifier when a system user supplies it to the system via a remote electronic computing device displaying the ecommerce site. Thus, the at least one electronic contact identifier may be sent to the at least one server via the website. The electronic contact identifier may be sent to the at least one server along with sales transaction data such as item number(s) for the item(s) desired to be purchased and shipped, order number, purchaser name and address, purchaser credit card data, etc. Upon receipt, the system server may send the obtained information to the at least one database for storage. The at least one server may additionally prompt the system user via the webpage to enter shipping address entry page display preferences. These shipping address entry page display preferences may permit the system user to control some or all of the information that is displayed at a shipping address entry page.

Upon receipt of at least one electronic contact identifier, the at least one server may generate a message which contains a link to a shipping address entry page. In preferred exemplary embodiments, the link is correlated not only to a shipping address entry page, but also specifically correlated to all or part of the underlying sales transaction data. Accordingly, the system may be able to correctly correlate an obtained shipping address with the underlying purchase information based on the link through which the shipping address was obtained. The correlation may permit for the system to send the proper item(s) to the obtained address, initiate payment processing, etc. Similarly, when multiple addresses are needed for a single purchase, the system may generate distinct links for each address needed so that each link leads to a distinct shipping address entry page and the system may then be able to correctly correlate an address that is ultimately obtained at each of the pages with the item(s) the purchaser desires to be shipped to that address. The shipping address entry page may also be run by the at least one server and may prompt for the entry of data in addition to a shipping address.

The at least one server may be able to complete a sales transaction upon receipt of a shipping address that has been entered into a shipping address entry page. Completion of a sales transaction may mean that the system causes payment for the sale to be processed or causes the purchased item(s) to be shipped to the obtained address or both. In some exemplary embodiments, the at least one server is able to cancel all or part of a sales transaction when at least one shipping address, that was needed for shipping all or part of a placed order, is not obtained. In some exemplary embodiments where the server cancels a sales transaction, it generates a message and causes the message to be sent to the individual that attempted to make the purchase where the message indicates that the order was cancelled. The message may be sent via email, text message, etc. and may be sent by the system using an electronic contact identifier that was sent to the at least one system server when the order was being placed. In some instances an order may only be partially cancelled by the system.

Some exemplary embodiments of the system and method comprise the sending of a message to at least one cell phone. This may be because a cell phone number was provided to the system as an electronic contact identifier to be utilized in obtaining at least one shipping address for completing a sales transaction. In exemplary embodiments where a cell phone number is obtained as an electronic contact identifier for obtaining a shipping address, the system may generate a message using short message service, also referred to as SMS. In another exemplary embodiment, the system may generate a message via an email system that is then sent using the cell phone number that was provided as the electronic contact identifier such that the message, though generated through an email system, is received as a text message on the cell phone that corresponds to the obtained cell phone number. In such an exemplary embodiment, the system may need to know a US and international cellular provider address to complete the sending of the message. In some exemplary embodiments, this information may be learned by searching through a database using the cell phone number that was entered by the purchaser. Common US and international cellular provider addresses that may be utilized by the system in sending a message for obtaining a shipping address are:

| Service Provider | Text Address |
|---|---|
| Verizon | @vtext.com |
| AT&T | @txt.att.net |
| Sprint | @messaging.sprintpcs.com |
| Virgin Mobile USA | @vmobl.com |
| T-Mobile | @tmomail.net |
| Boost Mobile | @myboostmobile.com |
| Cricket | @mmms.mycricket.com |

So for example, if the system obtains cell phone number (614)-111-1111 as an electronic contact identifier to be utilized in obtaining a shipping address, it may generate a message via an email system and send the message to 6141111111@vtext.com which may then be received as a text message on the cell phone corresponding to the (614)-111-1111 number. Preferably, the message contains a link to a shipping address entry page where a shipping address may then be provided to the system.

In some exemplary embodiments, the system may send a message to at least one cell phone so that a purchaser may be updated regarding order status. For example, a message sent to a cell phone may inform a purchaser that a sales transaction has been completed and at least part of the purchase has shipped to a shipping address that was obtained by the system. In other exemplary embodiments, a message sent to a purchaser via a cell phone may inform the purchaser that at least one shipping address needed to complete the transaction was not obtained and accordingly the corresponding part of the transaction was cancelled or refunded. Messages may also be sent if an item ordered through an ecommerce site has become unavailable, backordered, etc. The system may utilize a phone number that was entered by the purchaser as his or her electronic contact identifier when the sales transaction was initiated. As was the case with messages generated in order to obtain a shipping address, the system may generate at least one message for a purchaser and send it to a cell phone via SMS, an email system, or similar system capable of generating a text message. In some exemplary embodiments, the system user that initiated the sales transaction may be able to instruct the system how he or she would like to be updated regarding the status of the sales transaction. When the purchaser makes his purchase/places his order he may be prompted by the system to provide the system with parameters for the transaction. These parameters may include when and under what circumstances the system should cancel the order, how he or she should be updated regarding the status of the transaction (i.e. what form of communication should the system use to contact him, how often should he be contacted regarding status, etc).

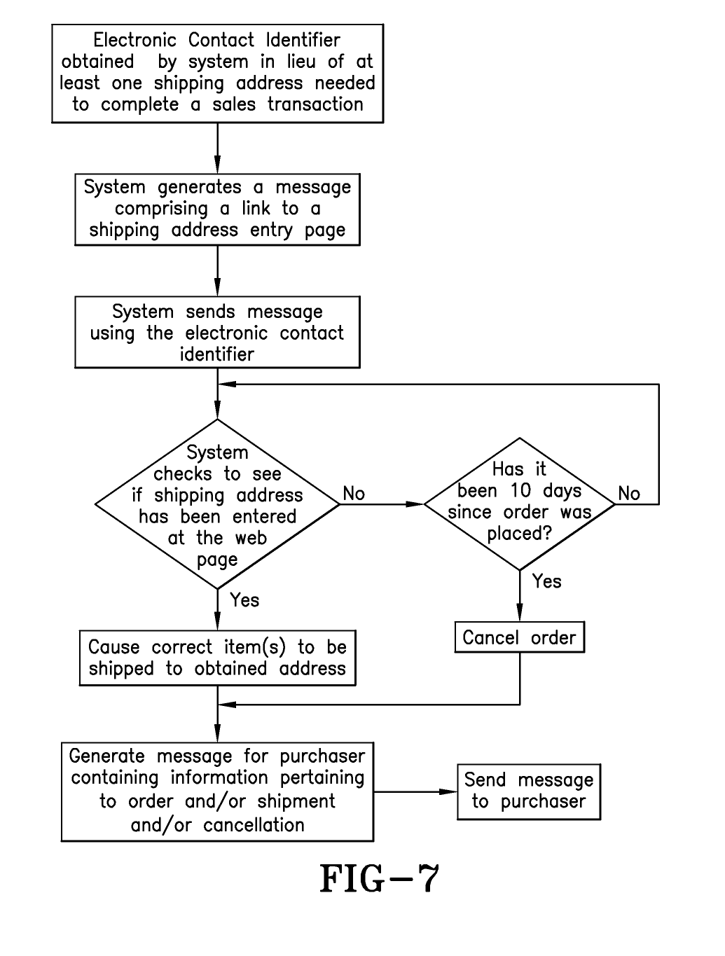

FIG. 7 shows a flow chart for an exemplary embodiment of the present system. As shown, the system may obtain an electronic contact identifier in lieu of a shipping address needed to complete a sales transaction. Upon receipt of the electronic contact identifier, the system may generate a message (such as a text message, email message, tweet, post for a web page, etc.) that contains a link to a shipping address entry page. Once generated, the system may cause the message to be sent using the obtained electronic contact identifier. Once the message has been sent, the system may check—periodically or continuously—to see if a shipping address has been entered at the shipping address entry page. If a shipping address has been entered, the system may cause a payment to be processed and may cause the correct items to be shipped to the obtained address. Alternatively, if no shipping address has been obtained, the system may check to see how long it has been since the order was placed and may cause the order to be cancelled if the order was placed outside of a given time period. In the exemplary system depicted by FIG. 7, that time period is ten days, but a shorter or longer time period may also be utilized by the system. Once at least part of an order has been shipped or cancelled, the system may generate a message for the purchaser. In preferred exemplary embodiments, the message will inform the purchaser of the action that has taken place (i.e. whether the payment was processed and shipment occurred, whether at least part of the order was cancelled, etc.) Once the message for the purchaser has been generated, the system preferably causes the message to be sent. As discussed above, the system may be sent using an electronic contact identifier that was provided to the system during the sales transaction.

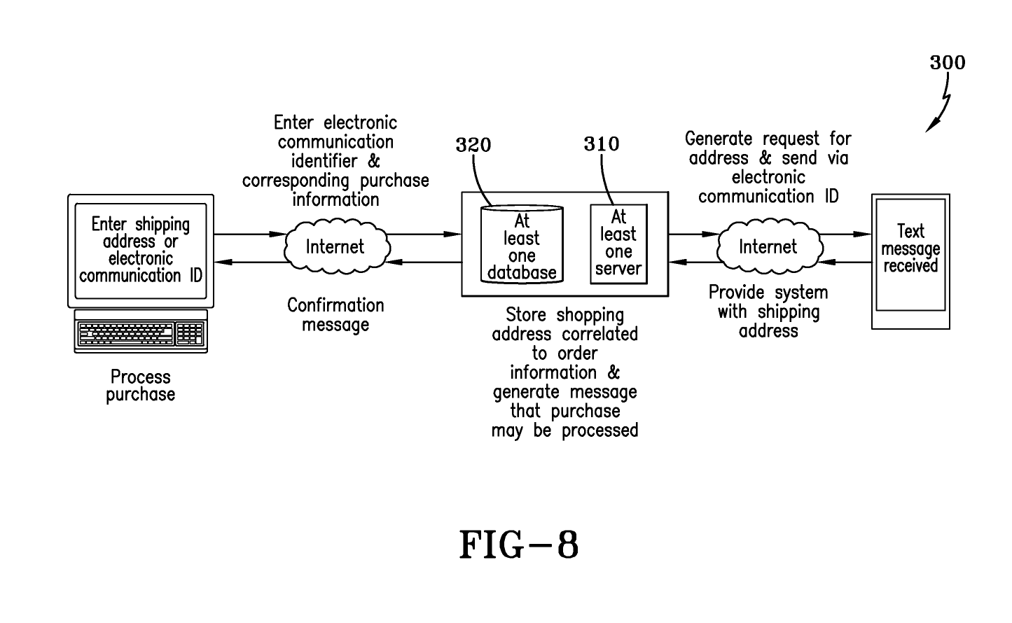

As shown in FIG. 8, an exemplary embodiment may comprise a system 300 for using at least one electronic communication identifier to obtain a shipping address needed to complete a purchase that was not placed through an ecommerce site. As shown in the figure, such a system may be used to obtain a shipping address corresponding to an order that was not placed over an online shopping site. The purchase may have been made at a retail store, through a catalog, over the phone to a merchant, etc. In such exemplary embodiments, at least one system server 310 may run a webpage which may be accessed by a system user for the entry of at least one electronic contact identifier that will be used to obtain shipping information for at least one item being purchased. The system user may be a merchant that has obtained an order for merchandise, a purchaser using the system at a retail store, etc. In some exemplary embodiments, the system server may also prompt the user for entry of information pertaining to the item which has been or is desired to be purchased, order information such as a corresponding order number, etc. In some exemplary embodiments, once the server has obtained information from a system user, it sends the information to at least one database 320 where order/purchase information is correlated to the obtained electronic contact identifier(s) and stored. Once the system has obtained the electronic contact identifier(s) it may generate a message comprising a secure link to a webpage where a shipping address may be entered and sent to the at least one system server. The system server may receive the shipping address after it has been entered at the shipping address entry page and correlate it to the corresponding order information that has been saved in the database. The server may then cause a payment for the portion of the purchase that corresponds to the received shipping address (which may be all of the purchase but may also be a lesser portion in some exemplary embodiments) to be processed and cause the portion of the purchase to be send to the obtained shipping address. In exemplary embodiments where the purchase was already placed, the system may generate a message that the purchase is ready to be shipped. In some exemplary embodiments, such a system may operate the same as the discussed exemplary systems for obtaining a shipping address that was placed through an ecommerce site.

Any embodiment of the disclosed system and method may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

What is claimed is:

1. A computerized system for obtaining a shipping address needed to complete a sales transaction comprising at least one server in electronic communication with a database wherein the at least one server is adapted to:
receive electronic contact identifier data and sales transaction data from a remote electronic computing device wherein the sales transaction data comprises information identifying at least one item selected for purchase from a retailer that needs to be shipped to an address to be obtained by the system;
send the sales transaction data to the database for storage;
generate an electronic message comprising a link to a webpage;
cause the message to be sent using the electronic contact identification data;
generate at least one webpage accessible using the link wherein the webpage displays at least one data entry field for entry of the shipping address;
receive the shipping address that has been provided to the at least one data field of the webpage;
initiate payment processing for the at least one item; and
cause the at least one item to be shipped to the shipping address.

2. The system of claim 1 wherein the at least one server is further adapted to generate and send a second message indicating that the shipping address was obtained and the at least one item has been purchased and shipped.

3. The system of claim 1 wherein the electronic contact identifier data is selected from the group consisting of a phone number, an email address, a twitter username, a personal webpage URL, and an instant messaging username.

4. The system of claim 1 wherein the at least one server is further adapted to receive instructions from the remote electronic computing device as to what information should be displayed at the generated webpage and generate the shipping address entry page in accordance with the received instructions.

5. The system of claim 1 wherein the at least one server is further adapted to:
receive a personal message that has been entered at the remote electronic computing device; and
incorporate the personal message into the generated electronic message before it is sent using the electronic contact identifier data.

6. The system of claim 1 wherein the at least one server is further adapted to:
receive electronic contact identifier data pertaining to the initiator of the sales transaction;
receive a request via the generated webpage to send a message for the at least one item selected for purchase; and
cause the message to be sent using the electronic contact identifier data pertaining to the initiator of the sales transaction.

7. The system of claim 6 wherein the message is a customizable thank you message.

8. A computerized system for obtaining a shipping address needed to complete a sales transaction comprising at least one server in electronic communication with a database wherein the at least one server is adapted to:
receive electronic contact identifier data and sales transaction data from a remote electronic computing device wherein the sales transaction data comprises information identifying at least one item selected for purchase from a retailer that needs to be shipped to a shipping address to be obtained by the system;
send the sales transaction data to the database for storage;
generate a unique code corresponding to the sales transaction;
generate an electronic message comprising the unique code;
cause the message to be sent using the electronic contact identification data;
generate a webpage wherein the webpage displays at least one data entry field for entry of the unique code and at least one data entry field for entry of the shipping address;
receive the unique code and shipping address after entry into the data fields;
validate the unique code;
receive the shipping address that has been provided to the at least one data field of the webpage; and
cause the at least one item to be shipped to the shipping address.

9. The system of claim 8 wherein the at least one server is further adapted to:
incorporate a secure link to the webpage into the message prior to it being sent using the electronic contact identifier data.

10. The system of claim 9 wherein utilization of the secure link to access the webpage precludes having to enter the unique code at the webpage.

11. The system of claim 8 wherein the at least one server is further adapted to initiate payment processing for the at least one item upon validating the unique code and receiving the shipping address.

12. The system of claim 8 wherein the electronic contact identifier data is selected from the group consisting of an email address, a phone number, a twitter username, a personal webpage URL, and an instant messaging username.

13. The system of claim 8 wherein the at least one server is further adapted to:
receive electronic contact identifier data pertaining to the initiator of the sales transaction;
receive personal message data entered at the generated webpage; and
cause the personal message data to be sent using the electronic contact identifier data pertaining to the initiator of the sales transaction.

14. The system of claim 8 wherein the at least one server is further adapted to:
receive instructions from the remote computing device regarding information that is to be displayed at the generated webpage; and
generate the webpage in accordance with the instructions.

15. The system of claim 8 wherein the remote computing device is selected from the group consisting of a smart phone, a laptop computer, a desktop computer, a computing tablet, and a computer network.

16. A computerized method for obtaining a shipping address needed to complete a sales transaction comprising the steps of:
receiving at a server sales transaction data and electronic contact identifier data wherein the sales transaction data identifies at least one item that has been selected for purchase during a sales transaction wherein the at least one item is to be shipped to a shipping address that is to be obtained using the computerized method;
generating at said server a message comprising a link to a webpage where the shipping address may be provided;
electronically transmitting the message using the electronic contact identifier data;
generating at said server a webpage comprising at least one data entry field which may be utilized to obtain the shipping address;
transmitting the webpage for display at a remote computing device;
receiving the shipping address from the remote computing device after it has been entered by a system user at the at least one data entry field of the webpage; and
in response to receiving the shipping address, initiating payment processing for the at least one item and initiating shipment of the at least one item to the shipping address.

17. The computerized method of claim 16 further comprising the steps of:
receiving at said server electronic contact identifier data corresponding to an initiator of the sales transaction;
generating at said server a status update message which indicates whether the shipping address has been obtained; and
transmitting the status update message using the contact identifier data corresponding to the initiator of the sales transaction.

18. The computerized method of claim 16 further comprising the steps of:
generating at said server a unique code which corresponds to at least part of the sales transaction;
incorporating the unique code into the message along with the link to the webpage;
generating a data entry field within the webpage for entry of the unique code;
receiving at said server the unique code after it has been entered into the data entry field at the webpage;
at said server validating the unique code; and
making initiation of payment processing and initiation of shipment conditional on successful validation of the unique code.

19. The computerized method of claim 16 further comprising the steps of:
receiving at said server instructions pertaining to what information is to be displayed within the generated webpage; and
generating the webpage in accordance with the received instructions.

20. The computerized method of claim 19 wherein the instructions indicate whether the name of an individual or entity that initiated the sales transaction is to be displayed within the generated webpage and further indicate whether the at least one item is to be identified within the webpage.
